(19) United States
(12) Patent Application Publication
(10) Pub. No.: US 2004/0239792 A1
(43) Pub. Date: Dec. 2, 2004

(54) Image display apparatus and image display method

(75) Inventors: Atsushi Shibutani, Tokorozawa-shi (JP); Masami Yuyama, Ome-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/869,710

(22) Filed: Jun. 15, 2004

Related U.S. Application Data
(63) Continuation of application No. PCT/JP03/12676, filed on Oct. 2, 2003.

(30) Foreign Application Priority Data
Oct. 3, 2002 (JP) 2002-291234
Aug. 14, 2003 (JP) 2003-293424

(51) Int. Cl. H04N 5/222

(52) U.S. Cl. 348/333.12

(57) ABSTRACT

An image display apparatus comprises a memory card which acquires images of different aspect ratios, a display unit which displays an acquired image, the display unit having a display screen of a different aspect ratio, a vertical/horizontal position sensor which detects the direction of the display screen of the display unit, and a control unit which changes the display direction and the size of the image to be displayed by the display unit, based on the result of detection by the vertical/horizontal position sensor.

### CROSS-REFERENCE TO RELATED APPLICATIONS

This is a Continuation Application of PCT Application No. PCT/JPO 3/12676, filed Oct. 2, 2003, which was published by the International Bureau on Apr. 15, 2004 (15.04.2004) under No. WO 2004/032492.

This application is based upon and claims the benefit of priority from prior Japanese Patent Applications No. 2002-291234, filed Oct. 3, 2002; and No. 2003-293424, filed Aug. 14, 2003, the entire contents of both of which are incorporated herein by reference.

### BACKGROUND OF THE INVENTION

1. Field of the Invention

The present invention relates to an image display apparatus and an image display method adapted for use with a digital camera.

2. Description of the Related Art

In a prior art, a method of reading image data stored in a buffer memory is changed at the time of picking up an image in a portrait mode so that a superimposed image is displayed in a correct direction on a liquid crystal display panel thereby to improve the visibility of the image.

In another prior art, an image display LCD on the back of a camera is supported on a rotary plate, which is rotated in accordance with the direction of the image displayed on the LCD thereby to display the image in a correct direction.

In the former art, however, a superimposed image on a liquid crystal display panel arranged on a camera body is intended to be displayed in the correct direction matching an object image displayed on a TV monitor separate from the camera body thereby to improve the visibility. This art fails to take into consideration, at the time of reproduction, in which of the vertical and horizontal directions the image temporarily recorded in a digital still camera or the like has been picked up.

In the latter art, on the other hand, the user manipulates the rotary plate on the back of the camera thereby to display an image in the correct direction on the image display LCD. In the process, the user is required to determine the direction of rotation of the rotary plate to assure the correct direction of the image and rotate the rotary plate based on the determination result.

In addition, according to the latter art, the image display LCD is arranged on the inside of a discal rotary plate occupying a part of the back of the camera, with the result that the area of the LCD on the back of the camera is very small.

Even though an image can be displayed in the correct direction on the LCD, therefore, the small area of the LCD makes it difficult to check the detailed parts in the image thereby leading to the likelihood of low visibility of a displayed image.

### BRIEF SUMMARY OF THE INVENTION

The present invention has been achieved in view of the actual situation described above and an object thereof is to provide an image display apparatus and an image display method in which a reproduced image is displayed in a more easily visible manner by utilizing the display screen.

According to an aspect of the present invention, an image display apparatus comprises:

an acquire unit which acquires an image;

a display unit which displays the image acquired by the acquire unit, the display unit having a display screen;

a detector which detects an orientation of the display screen of the display unit; and

a change unit which changes an orientation and a size of the image displayed by the display unit, based on a result of detection by the detector.

According to another aspect of the present invention, an image display apparatus comprises:

an image acquire unit which acquires an image;

a display unit which displays the image acquired by the image acquire unit, the display unit having a display screen;

an information acquire unit which acquires information indicating an aspect ratio of the image acquired by the image acquire unit; and

a determining unit which determines an orientation and a size of an image to be displayed by the display unit, based on the information indicating the aspect ratio acquired by the information acquire unit.

According to still another aspect of the present invention, an image display apparatus comprises:

an image acquisition unit which acquires an image;

an image display unit which displays the image acquired by the image acquisition unit, the image display unit having a display screen;

a detector which detects an orientation of the display screen of the image display unit; and

a display control processor which changes an orientation and a size of an image displayed by the image display unit, based on a result of detection by the detector.

According to still another aspect of the present invention, an image display apparatus comprises:

an image acquisition unit which acquires an image;

an image display unit which displays the image acquired by the image acquisition unit, the image display unit having a display screen;

an aspect ratio acquisition unit which acquires information indicating an aspect ratio of the image acquired by the image acquisition unit; and

a display control processor which determines an orientation and a size of an image to be displayed by the image display unit, based on the information indicating the aspect ratio acquired by the aspect ratio acquisition unit.

According to still another aspect of the present invention, an image display method comprises:

acquiring an image;

detecting an orientation of an image display unit which displays the acquired image; and

changing an orientation and a size of an image displayed by an image display unit, based on a result of detection.

According to still another aspect of the present invention, an image display method comprises:

acquiring an image;

acquiring information indicating an aspect ratio of the acquired image; and

determining an orientation and a size of an image to be displayed by an image display unit, based on the acquired information indicating the aspect ratio.

According to still another aspect of the present invention, an article of manufacture comprises a computer usable medium having computer readable program code means embodied therein, the computer readable program code means comprises:

computer readable program code means for causing a computer to acquire an image;

computer readable program code means for causing a computer to detect an orientation of an image display unit which displays the acquired image; and

computer readable program code means for causing a computer to change an orientation and a size of an image displayed by the image display unit, based on the detected orientation.

According to still another aspect of the present invention, an article of manufacture comprises a computer usable medium having computer readable program code means embodied therein, the computer readable program code means comprises:

computer readable program code means for causing a computer to acquire an image;

computer readable program code means for causing a computer to acquire information indicating an aspect ratio of the acquired image; and

computer readable program code means for causing a computer to determine an orientation and a size of an image displayed by an image display unit, based on the information indicating the aspect ratio of the acquired image acquired by code means.

### BRIEF DESCRIPTION OF THE SEVERAL VIEWS OF THE DRAWING

FIG. 1 is a block diagram showing a circuit configuration of a digital camera according to a first embodiment of the invention;

FIG. 2 is a flowchart showing a process executed in an image pickup mode according to the first embodiment;

FIG. 3 is a flowchart showing a process executed in a normal reproduction mode according to the first embodiment;

FIG. 4 is a flowchart showing a process executed in an enlarged reproduction mode according to the first embodiment;

FIGS. 5A and 5B are views illustrating the appearance of the digital camera and a state of an image displayed in the enlarged reproduction mode according to the first embodiment;

FIGS. 6A and 6B are views illustrating the appearance of a digital camera and a state of an image displayed in the enlarged reproduction mode according to the first embodiment;

FIGS. 7A, 7B, 7C and 7D are diagrams illustrating information indicating the bottom side of an image recorded as related to image data, according to the first embodiment;

FIGS. 8A and 8B are diagrams illustrating information indicating the pixel size recorded as related to image data;

FIG. 9 is a block diagram showing a circuit configuration of a portable telephone with camera according to a second embodiment of the invention;

FIGS. 10A and 10B are views illustrating the appearance of the portable telephone with camera and states of images displayed in a normal reproduction mode and an enlarged reproduction mode; and

FIGS. 11A and 11B are flowcharts showing a process in the normal reproduction mode and the enlarged reproduction mode according to the second embodiment.

### DETAILED DESCRIPTION OF THE INVENTION

Embodiments of the invention are described below with reference to the drawings.

(First Embodiment)

An embodiment of the present invention applied to a digital still camera (hereinafter referred to as digital camera) is explained below with reference to the drawings.

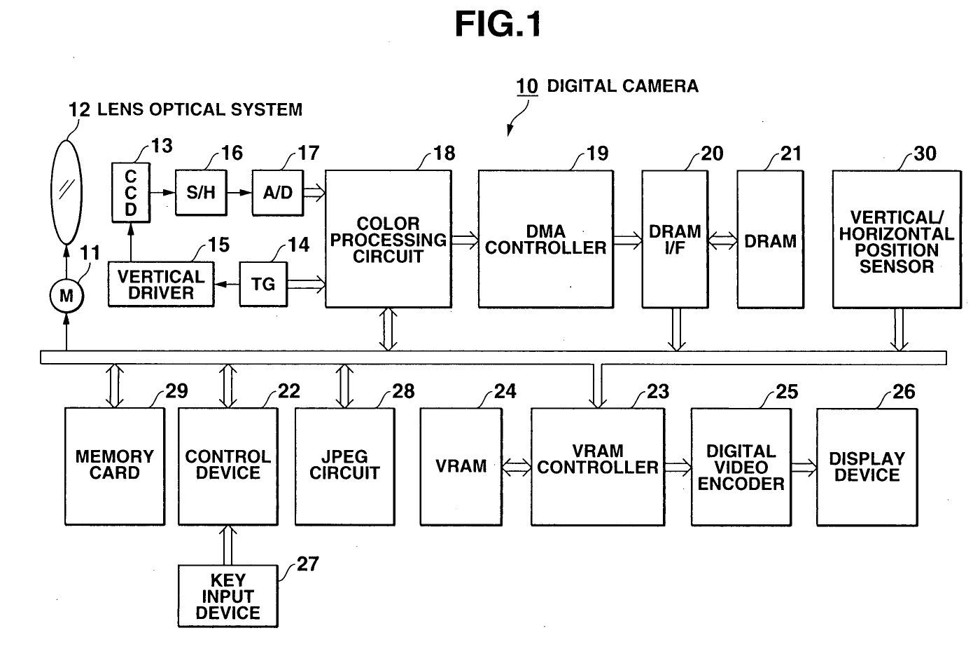

FIG. 1 shows a circuit configuration, in which reference numeral 10 designates a digital camera. The basic mode of the digital camera 10 can be set by switching between an image pickup mode and a reproduction mode. When monitoring in the image pickup mode, a CCD 13, which corresponds to an image pickup element arranged rearward of the image pickup optical axis of a lens optical system 12 with the focusing point and the stop point thereof moved by the drive of a motor (M) 11, is scanned and driven by a timing generator (TG) 14 and a vertical driver 15, and outputs one frame of photoelectric conversion output corresponding to an optical image formed for each predetermined period.

The photoelectric conversion output is adjusted in gain appropriately for each primary color component of R, G or B in the form of an analog signal, sample & held by a sample hold circuit (S/H) 16, and being converted into digital data by an A/D converter 17, output to a color processing circuit 18.

The color processing circuit 18 performs the color processing including the pixel interpolation and the gamma correction of the digital data of the image sent from the A/D converter 17, generates a brightness signal Y and color difference signals Cb and Cr in digital value, and outputs them to a DMA (direct memory access) controller 19.

The brightness signal Y and the color difference signals Cb and Cr which are output from the color processing circuit 18 are written by the DMA controller 19 in a buffer in the DMA controller 19 using a composite sync signal, a memory write enable signal and a clock signal from the color processing circuit 18, and through a DRAM interface (I/F) 20, transferred and output to a DRAM 21 used as a buffer memory.

A control unit 22 comprises a CPU, a ROM for storing an operation program and a RAM constituting a work memory to control the overall operation of the digital camera 10. The brightness signal and the color difference signals, after DMA-transfer to the DRAM 21, are read from the DRAM 21 through the DRAM interface 20 and written in a VRAM (video RAM) 24 through a VRAM controller 23.

A digital video encoder 25 reads the brightness signal and the color difference signals regularly from the VRAM 24 through the VRAM controller 23, and generates a video signal based on the data thereby to output the video signal to a display unit 26.

The display unit 26 comprises, for example, a color liquid crystal display panel with a back light and a drive circuit. The display unit 26 is arranged fixedly on the back side of the body of the digital camera 10 and functions as a monitor display unit (electronic finder) in the image pickup mode. An image is displayed based on the video signal from the digital video encoder 25. Thereby, an image based on the image information picked up by the CCD 13 and fetched from the VRAM controller 23 at present is displayed.

While the image at present is on display on the display unit 26 as a real-time monitor image, a shutter key included in a plurality of keys configuring a key input unit 27 is operated at the desired timing of picking up a still image. Thus, a trigger signal is generated.

Immediately after the brightness signal and the color difference signals of one frame fetched from the CCD 13 at present corresponding to the trigger signal are DMA-transferred to the DRAM 21, the control unit 22 deactivates the path from the CCD 13 to the DRAM 21 and shifts to the recording and storage operation.

In the recording and storage operation, one frame of the brightness signal and the color difference signals written in the DRAM 21 are read by the control unit 22 through the DRAM interface 20 in units called the basic block, i.e. eight pixels vertical by eight pixels horizontal, for each component of Y, Cb and Cr, and written in a JPEG (Joint Photograph Coding Experts Group) circuit 28. In the JPEG circuit 28, the data are compressed by the process including ADCT (Adaptive Discrete Cosine Transform) and the Huffman coding constituting an entropy coding scheme.

The coding data thus obtained are read from the JPEG circuit 28 as a data file of one frame, and written in a memory card 29 having sealed therein a flush memory constituting a nonvolatile memory, which is replaceably mounted as a recording medium of the digital camera 10.

With the completion of the process of compressing one frame of the brightness signal and the color difference signals and writing all the compressed data into the memory card 29, the control unit 22 reactivates the path from the CCD 13 to the DRAM 21.

The control unit 22 is further connected with a vertical/horizontal position sensor 30. The vertical/horizontal position sensor 30 comprises, for example, a pair of inclination sensors arranged at right angles to each other in the housing of the digital camera 10. If the digital camera 10 is stored in a position adapted to pick up an image substantially long in the horizontal direction (hereinafter referred to as “horizontal position” or “landscape position”) or in a position adapted to pick up a vertically long image (hereinafter referred to as “vertical position” or “portrait position”), the vertical/horizontal position sensor 30 detects the particular position and outputs the detection result to the control unit 22.

In addition to the shutter key described above, the key input unit 27 comprises a mode switching key for switching between the image pickup (REC) mode and the reproduction (play) mode constituting the basic modes, a “menu” key for displaying various menu items, a cross key for designating the four directions of up, down, right and left to select images and various detailed modes and designate menu select items, a “set” key arranged at the central part of the cross key for designating and setting the contents selected at present, and a display key for turning on/off the display operation of the display unit 26. The signals resulting from the operation of these keys are sent out directly to the control unit 22.

Next, the operation of this embodiment is described.

Assume that the aspect ratio (ratio of vertical length to horizontal length) of the image data picked up by the CCD 13 and recorded on the memory card 29 and the aspect ratio of the image capable of being displayed by the display unit 26 are the same 3 to 4, and unless the direction in which the image data is picked up is taken into consideration, the image data can be displayed over the entire area of the display screen of the display unit 26.

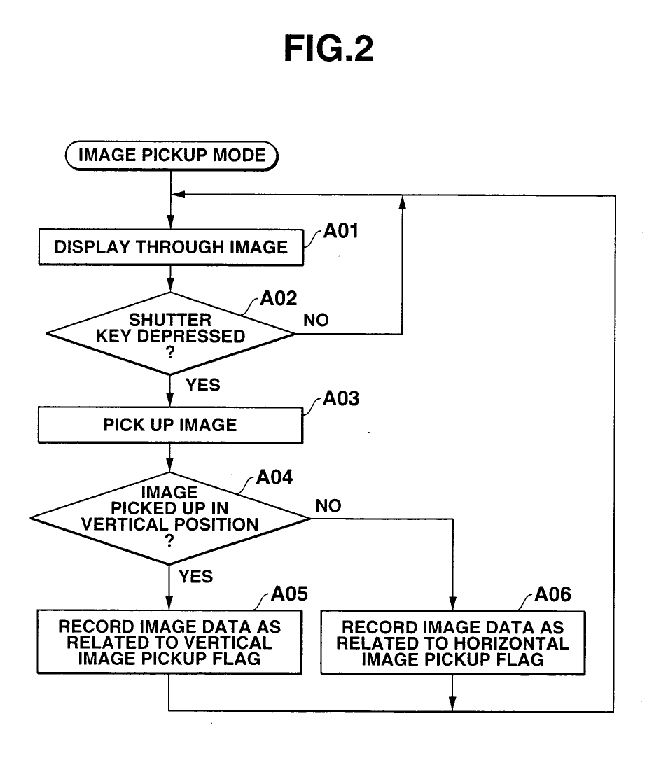

FIG. 2 shows the contents of the processing based on the operation program executed mainly by the control unit 22 If the image pickup mode is selected as the basic mode.

In the initial stage of the processing, the images picked up by the CCD 13 are sequentially stored in the DRAM 21 constituting a buffer memory, and while maintaining the through image display mode for monitor display on the display unit 26 (step A01), it is determined whether or not the shutter key of the key input unit 27 is depressed (step A02). This process is repeatedly executed in anticipation of the operation of the shutter key from the through image display mode.

At the time when it is determined in step A02 that the shutter key is depressed, the image pickup process is immediately executed (step A03).

Based on the output from the vertical/horizontal position sensor 30, it is determined whether or not the particular image pickup operation is performed in the vertical position (portrait position) of the digital camera 10 (step A04).

If it is determined that the image pickup operation is performed in the vertical position of the digital camera 10, flag information indicating the image pickup in the vertical position (the flag information may alternatively be embedded in the image file) as related to the picked-up image data are recorded and set on the memory card 29 (step A05). A series of the image pickup process is thus completed and the control is returned to step A01 in preparation for the next image pickup session.

If it is determined in step A04 that the image pickup operation is performed not in the vertical position, the control unit 22, on the assumption that the image pickup operation is performed in the horizontal position (landscape position), sets and records the flag information indicating the image pickup operation in the horizontal position as related to the picked-up image data on the memory card 29 (step A06). A series of the image pickup process is thus ended, and the control returns to the process of step A01 again in preparation for the next image pickup session.

As described above, the flag information indicating the image pickup position as related to the image data is recorded on the memory card 29 at the time of image pickup operation.

In the aforementioned case, the flag information indicating the image pickup operation in the vertical position is recorded as related to the image data obtained by the image pickup operation in the vertical position, and the flag indicating the image pickup operation in the horizontal position is recorded as related to the image data obtained by the image pickup operation in the horizontal position. Alternatively, the flag information indicating the image pickup operation in only one of vertical and horizontal positions may be recorded as related to the image data. Also in this configuration, the horizontal position or the vertical position in which the image data is obtained by the image pickup operation can be discriminated.

Next, the operation is described in which the image data recorded with the related flag information indicating the image pickup position are read from the memory card 29 and reproduced and displayed by the display unit 26.

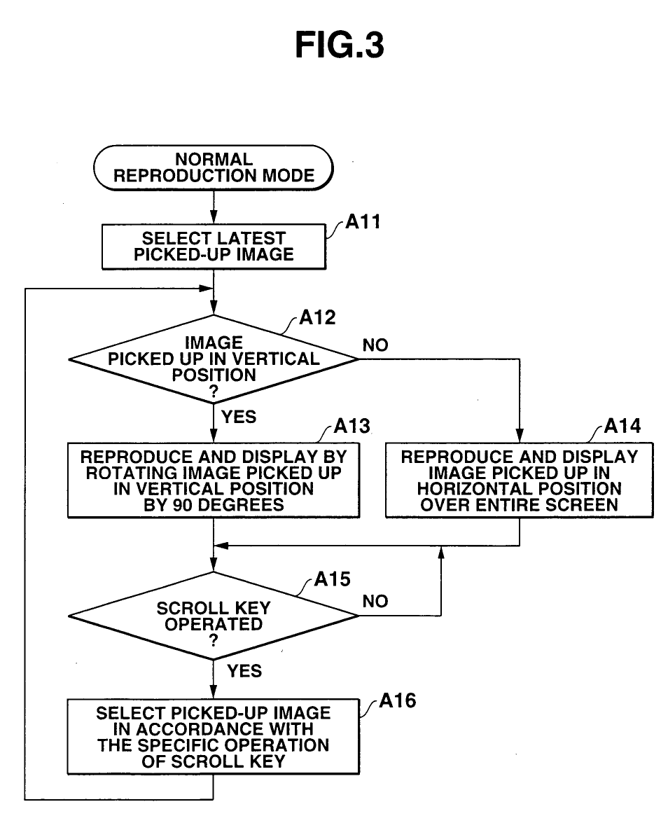

FIG. 3 shows the contents of the process based on the operation program executed mainly by the control unit 22 while the normal reproduction mode is selected as a basic mode by the user operation of the mode switching key of the key input unit 27.

In the beginning of the reproduction mode, the image data with the latest date information is selected from those recorded on the memory card 29 (step A11), and depending on whether or not the particular image data is related to the flag information indicating the image pickup operation in the vertical position, it is determined whether or not the particular image is picked up in the vertical position (step A12).

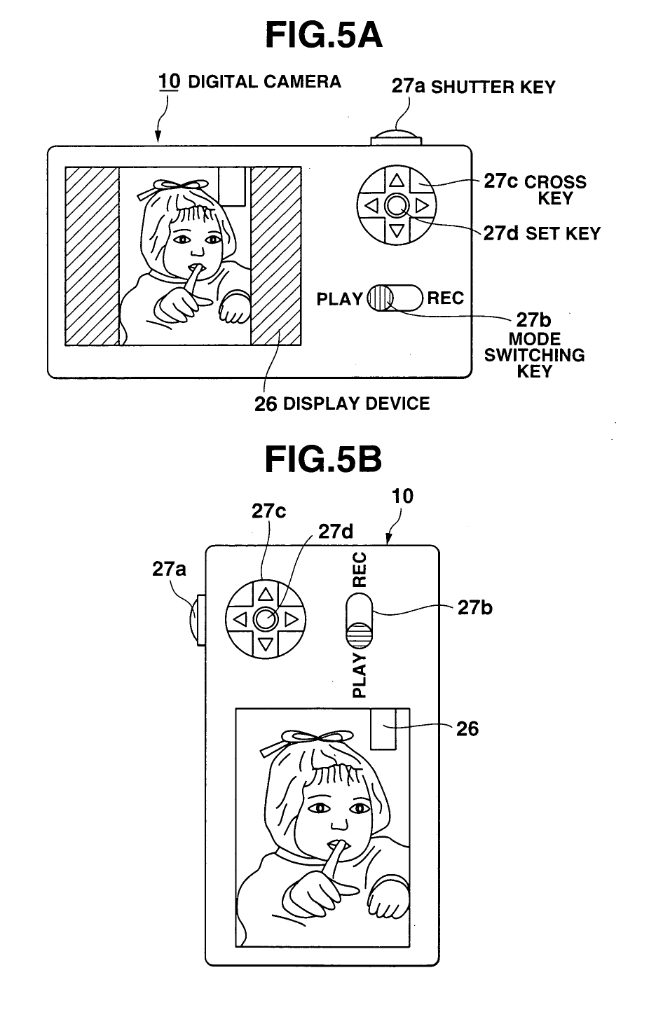

If the image data is related to the flag information indicating the image pickup operation in the vertical position and the image data is vertically long, as shown in FIG. 5A, the image data is rotated by 90 degrees while being resized, or specifically reduced to three fourths in length. Then, the image data is reproduced and displayed at the central portion of the display screen of the display unit 26 (step A13).

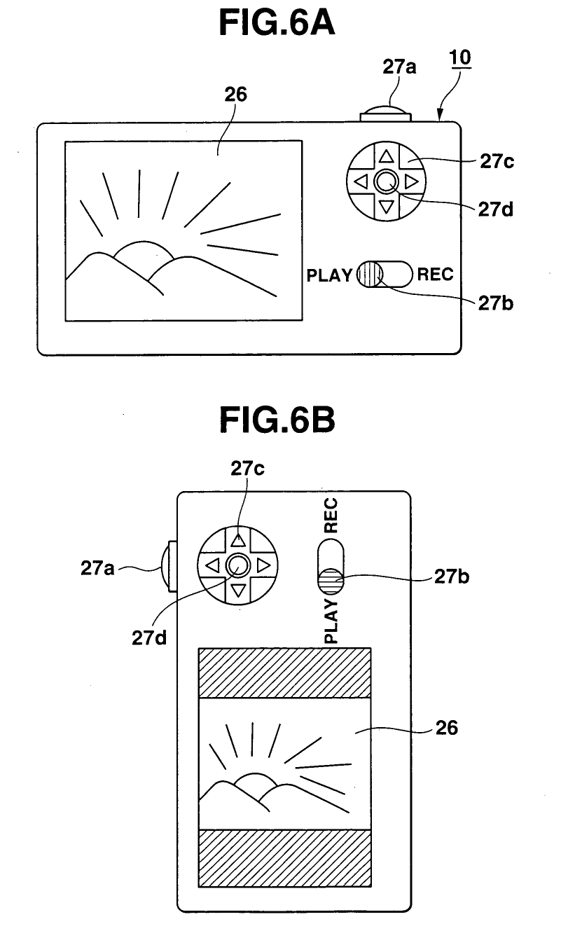

If the flag information indicating the image pickup operation in the horizontal position is related to the image data in step A12 and the particular data image is horizontally long, on the other hand, as shown in FIG. 6A, the image picked up in the horizontal position is reproduced and displayed over the entire display screen of the display unit 26 of the digital camera 10 held in the horizontal position (step A14).

Thereafter, it is determined whether or not the cross key 27c is manipulated to select a new image by scrolling (step A15), and when it is determined that the cross key 27c is so manipulated, new image data is selected from the memory card 29 to update by scrolling the screen of the display unit 26 in accordance with the specifics of the key operation (step A16). Then, the process returns to step A12 for determining whether or not the selected image data is picked up in the vertical position.

If it is determined in step B11 that the cross key 27c is manipulated, on the other hand, new image data is selected from the memory card 29 to update by scrolling the screen of the display unit 26 in accordance with the specifics of the key operation (step B07), after which the process returns to step B02.

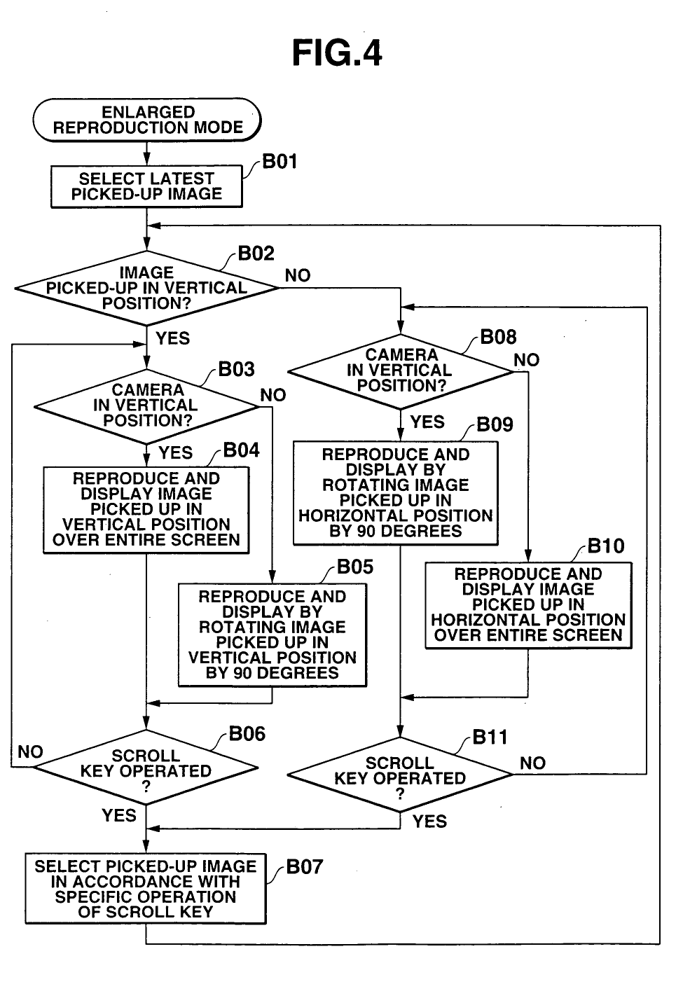

FIG. 4 shows the contents of the process performed based on the operation program executed mainly by the control unit 22 while the enlarged reproduction mode according to the invention is selected as a basic mode by the user manipulating the mode switching key of the key input unit 27.

In the beginning of the operation in the reproduction mode, the image data with the latest date information is selected from those recorded on the memory card 29 (step B01), and depending on whether or not the flag information indicating the image pickup operation in the vertical position is related to the particular image data, it is determined whether or not the particular image is vertically long (step B02).

If the image data is related to the flag information indicating the image pickup. operation in the vertical position and the particular image data is vertically long, it is determined by the detection signal from the vertical/horizontal position sensor 30 whether or not the digital camera 10 is held in the vertical position at present (step B03).

If it is determined that the digital camera 10 is in the vertical position, the selected image data is read from the memory card 29 and developed in the JPEG circuit 28. The particular image data obtained by the image pickup operation in the vertical position is reproduced and displayed over the entire area of the display screen of the display unit 26 (step B04).

FIG. 5B shows the state in which the image obtained by the image pickup operation in vertical position is reproduced and displayed in an enlarged form over the entire display screen of the display unit 26 of the digital camera 10 held in the vertical position.

The top and bottom of the image are coincident with the top and bottom of the display unit 26, respectively, at present. Therefore, the reproduced image can be displayed in a natural orientation on the one hand, and the fact that the whole display screen area of the display unit 26 is used makes it possible to display the image in a more enlarged form on the other hand.

Assume that a shutter key 27a is arranged on the upper surface of the digital camera 10, while a mode switching key 27b, a cross key 27c and a set key 27d are arranged in addition to the display unit 26 on the back of the digital camera 10.

Thereafter, it is determined whether or not the cross key 27c is operated to select the image anew by scrolling (step B06). When it is determined that the cross key 27c is not operated, the control returns to step B03. Until the vertical position of the digital camera 10 is canceled or the cross key 27c is operated, as shown in FIG. 5B, the image picked up in the vertical position is kept reproduced and displayed over the entire display screen of the display unit 26 of the digital camera 10 held in the vertical position.

When it is determined in step B03 from the detection output of the vertical/horizontal position sensor 30 that the digital camera 10 is not held in the vertical position, the process of step B04 is not executed. Instead, the image data is rotated by 90 degrees in accordance with the output of the vertical/horizontal position sensor 30 at present. In addition, the image data is resized, or specifically, compressed to three fourths in length, and displayed at the central portion of the display screen of the display unit 26 (step B05).

FIG. 5A shows the state in which the image picked up in the vertical position is reproduced and displayed at the central display portion of the display unit 26 of the digital camera 10 held in the horizontal position. Since the image is displayed using the central portion but not the end portions of the display screen of the display unit 26, the image size is reduced. Nevertheless, the top and bottom of the image are coincident with the top and bottom, respectively, of the display unit 26 at present, thereby making possible the reproduction and display in a natural orientation.

After the reproduction and display process in step B05, the process proceeds to step B06. While the image is kept reproduced and displayed at a part of the display screen of the display unit 26 of the digital camera 10 held in the horizontal position, the standby state is maintained waiting for the operation of the cross key 27c for selecting a new image by scrolling and the digital camera 10 turned to the vertical position.

If it is determined in step B06 that the cross key 27c is operated, new image data is selected from the memory card 29 to scroll and update the screen of the display unit 26 in accordance with the specifics of the key operation (step B07). Then, the process returns to step B02, where it is determined whether or not the selected image data is obtained by the image pickup operation in the vertical position.

If it is determined from the flag information related to the newly selected image data that the particular image is not picked up with the digital camera 10 held in the vertical position, then the same image is assumed to have been picked up with the digital camera 10 held in the horizontal position. Therefore, it is determined from the detection signal of the vertical/horizontal position sensor 30 whether or not the digital camera 10 is held in the vertical position at present (step B08).

If it is determined that the digital camera 10 is held in the vertical position, the selected image data is read from the memory card 29 and developed in the JPEG circuit 28. Further, in accordance with the output of the vertical/horizontal position sensor 30 at present, the image data developed is rotated by 90 degrees. At the same time, the image is resized, or specifically, reduced to three fourths in length and reproduced and displayed at the central portion of the display screen of the display unit 26 (step B09).

FIG. 6B shows the state in which the image picked up in the horizontal position is reproduced and displayed at the central portion without using the upper or lower end portions of the display unit 26 of the digital camera 10 held in the vertical position. The image is displayed using a part of the display screen of the display unit 26, and therefore the image size is reduced. Nevertheless, the top and bottom of the image coincide with the top and bottom, respectively, of the display unit 26 at present, thereby making possible the reproduction and display in a natural orientation.

In this way, the image is displayed by the display unit 26, while determining whether or not the cross key 27c is operated to scroll and select a new image (step B11). If it is determined that the cross key 27c is not operated, the process returns to step B08, and the state is maintained in which the image picked up in the horizontal position is reproduced and displayed at a part of the display screen of the display unit 26 of the digital camera 10 held in the vertical position, as shown in FIG. 6B, until the vertical position of the digital camera 10 is canceled or the cross key 27c is operated.

If it is determined in step B08 from the detection output of the vertical/horizontal position sensor 30 that the digital camera 10 is not held in the vertical position, the process of step B09 is not executed. Instead, the image data is read from the memory card 29 and developed in accordance with the output of the vertical/horizontal position sensor 30 at present, and reproduced and displayed over the entire display screen of the display unit 26 (step B10).

FIG. 6A shows a state in which the image picked up in the horizontal position is reproduced and displayed using the entire area of the display screen of the display unit 26 of the digital camera 10 held in the horizontal position.

The top and bottom of the image are coincident with the top and bottom, respectively, of the display unit 26 at present, and therefore the image can be reproduced and displayed in a natural orientation. Also, the use of the entire area of the display screen of the display unit 26 makes it possible to display the image in a larger size.

After the reproduction and display in step B10, the process proceeds to step B11, where the state in which the image is reproduced and displayed over the entire area of the display screen of the display unit 26 of the digital camera 10 held in the horizontal position is maintained, while waiting for the operation of the cross key 27c for selecting a new image by scrolling on the one hand and the digital camera 10 being changed to the vertical position on the other hand.

If it is determined that the cross key 27c is operated in step B11, new image data is selected from the memory card 29 to scroll and update the screen of the display unit 26 in accordance with the specific key operation (step B07), followed by returning to the process of step B02.

If the enlarged reproduction mode is selected as described above, the reproduction and display operation is performed at least in a natural orientation in such a manner that the top and bottom of the selected image are coincident with the top and bottom, respectively, of the display unit 26 at present. At the same time, as long as the vertical length and the horizontal length of an image to be displayed are coincident with those of the display unit 26, the reproduction and display operation can be performed over the entire area of the display screen of the display unit 26 and therefore the image can be displayed in a still larger size.

Once the user decides that the image reproduction in enlarged reproduction mode shown in FIG. 4 is not required, the user can select the normal reproduction mode to reproduce the image in the normal reproduction mode shown in FIG. 3, while at the same time reducing the burden on the control unit 22.

In the initial stage of the operation in the normal reproduction mode shown in FIG. 3 or in the enlarged reproduction mode shown in FIG. 4, the image data with the latest date information is selected, reproduced and displayed automatically, and subsequently, the image is selected in response to the scroll instruction by the operation of the cross key 27c. In the process, the image data may be recorded with a file name, a number or the like attached to the image data file, so that a key word or an image number is input for image search. A similar display control process may be executed at the time of selecting the image by automatic scroll.

The embodiment is described above as an application to a digital camera having a monitor display screen. The invention, however, is not limited to this embodiment but also applicable to portable equipment with a monitor display screen including portable information terminals such as an electronic notebook, a PDA and a portable TV set. In short, the invention is applicable to any equipment comprising a memory for storing a vertically long image and a horizontally long image in an identifiable way and a display unit having a different aspect ratio for displaying the images stored in the memory.

In addition to the portable devices having the monitor display screen described above, the invention also probably finds applications in stationary image display apparatuses such as an LCD monitor display of a desktop personal computer which can be used as a vertically long monitor screen by rotating a horizontally long monitor screen. In such a case, the vertical/horizontal position sensor included in the embodiment described above is not required, but detecting means such as a mechanical switch for detecting the rotation of the monitor screen.

According to this embodiment, the direction in which the image is displayed is changed as desired in accordance with the direction of the monitor screen for both the vertically long image and the horizontally long image. In an alternative configuration, the direction in which the image is displayed is changed appropriately in accordance with the direction of the monitor screen only for the vertically long image or the horizontally long image.

Also, according to the aforementioned embodiment, once the display screen switches from the horizontal position to the vertical position, the vertically long image which has thus far been compressed comes to be displayed over the entire area of the display screen. This is possible only if the aspect ratio of the image is coincident with that of the screen. The invention is applicable, however, also to a configuration in which even when the two aspect ratios are different from each other, the image thus far compressed can be displayed in an enlarged form as soon as the direction of the screen is changed. The same can be said of the horizontally long image as well as the vertically long image.

The embodiment is described above on the assumption that a vertically long image is the one picked up with the digital camera held in the vertical position and a horizontally long image is the one picked up with the digital camera held in the horizontal position, which are displayed on the monitor screen. The invention, however, is not limited to such a case, but also applicable to a case in which a vertically long image or a horizontally long image produced by the user on a personal computer (for example, an animation image plotted, a vertically long image produced by cutting the right and left sides of an image picked up in the horizontal position using a retouch software, a horizontally long image produced by cutting the upper and lower ends of an image picked up in the vertical position using a retouch software, etc.) is displayed on the monitor screen. In such a case, however, the flag information indicating the image pickup position is not recorded as related to the image data. It is, therefore, necessary for the user to relate the flag information indicating the image pickup position to the image data by manual input, or to determine whether a vertically long image or a horizontally long image is involved, by referring to the data indicating the vertical/horizontal sizes (pixel size) (for example, 640 (number of horizontal pixels)×480 (number of vertical pixels)) added to the image data generated at the time of producing the image.

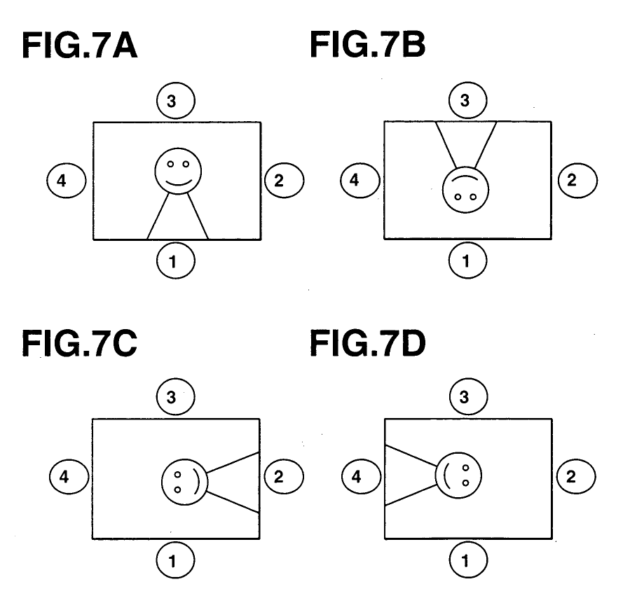

According to this embodiment, the flag information indicating the image pickup position is recorded as related to the image data. As an alternative, the information indicating the bottom side (or the upper side) of the image, in place of the flag information indicating the image pickup position, may be recorded as related to the image data. With regard to the image data picked up with the digital camera held in the horizontal position as shown in FIG. 7A, for example, number 1 is recorded as the information indicating the bottom side as related to the image data. With regard to the image data picked up with the digital camera held in the horizontal position, up side down, as shown in FIG. 7B, number 3 is recorded as the information indicating the bottom side as related to the image data. Similarly, with regard to the image data picked up with the digital camera held in the vertical position as shown in FIG. 7C or 7D, number 2 or 4 is recorded as the information indicating the bottom side as related to the image data. If the vertical/ horizontal position sensor 30 is not mounted on the digital camera 10, number 1 is recorded as default information indicating the bottom side as related to the image data, after which the user rewrites the bottom-side information manually as required.

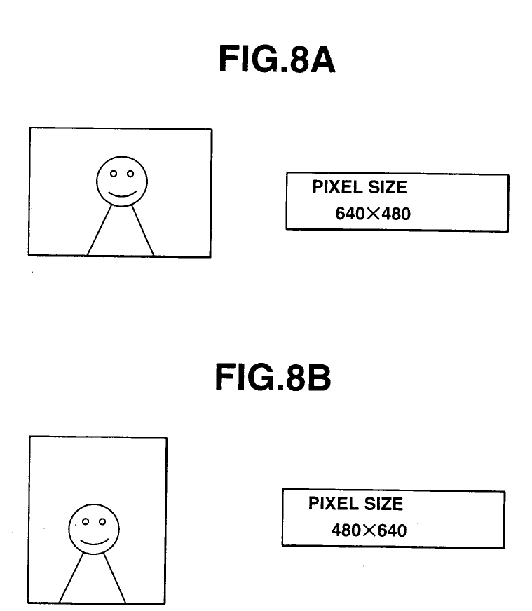

As another alternative, the data indicating the vertical and horizontal sizes are recorded as related to the image data as shown in FIGS. 8A and 8B, in place of the flag information indicating the image pickup position, and by referring to the data indicating the vertical and horizontal sizes at the time of image reproduction, it is determined whether a vertically long image or a horizontally long image is involved.

In the aforementioned embodiment, the vertical and horizontal positions of the digital camera are detected using the vertical/horizontal position sensor 30 at the time of image pickup operation, so that the image picked up in the horizontal position and the image picked up in the vertical position are automatically identified and recorded on the memory card 29 constituting a recording medium. Without using the vertical/horizontal position sensor 30, however, a shutter key for the image pickup operation in the vertical position and a shutter key for the image pickup operation in the horizontal position are provided, for example, so that the information for identifying a vertically long image or a horizontally long image is attached to the picked-up image and recorded according to which shutter key is operated. As another alternative, both the images in the vertical and horizontal positions are recorded indiscriminately at the time of image pickup operation, and subsequently, the user inputs the information for identifying a vertically long image and a horizontally long image by key input or the like and adds the information to the recorded image data. As still another alternative, the image pickup operation in the vertical position or the image pickup operation in the horizontal position is selected by the user immediately before the image pickup operation, and the picked-up image is recorded discriminably as a vertically picked-up image or a horizontally picked-up image according to which of the vertical and horizontal positions is selected at the time of the image pickup operation.

According to this embodiment, it is detected using the vertical/horizontal position sensor in the reproduction mode whether the digital camera is held in the vertical or horizontal position, and based on the detection result, the direction in which the selected image is displayed is changed. As an alternative, the apparatus may comprise a support structure capable of rotating the display screen vertically or horizontally, and the current rotation state of the display screen is detected thereby to change the direction in which the selected image is displayed.

Further, the embodiment is explained above with reference to a case in which the vertically long image and the horizontally long image are still images. The image data dealt with in this invention, however, are not limited to the still image but may alternatively be a moving image.

Furthermore, the aforementioned embodiment refers to the display control in the reproduction mode for displaying selected one of a plurality of image data obtained by the image pickup operation of the image pickup devices and recorded on the memory card 29 constituting a recording medium. The invention is also applicable, however, to the display control of a display unit for displaying the images acquired by receiving the satellite broadcast wave or the terrestrial broadcast wave and the images received through a communication network such as Internet. In this case, however, it is necessary to receive the image data having added thereto the discriminating information indicating whether a particular image is a vertically long image or a horizontally long image.

(Second Embodiment)

A portable telephone with camera (hereinafter referred to as portable telephone or cellular phone) to which an embodiment of the invention is applied is explained below with reference to the drawings.

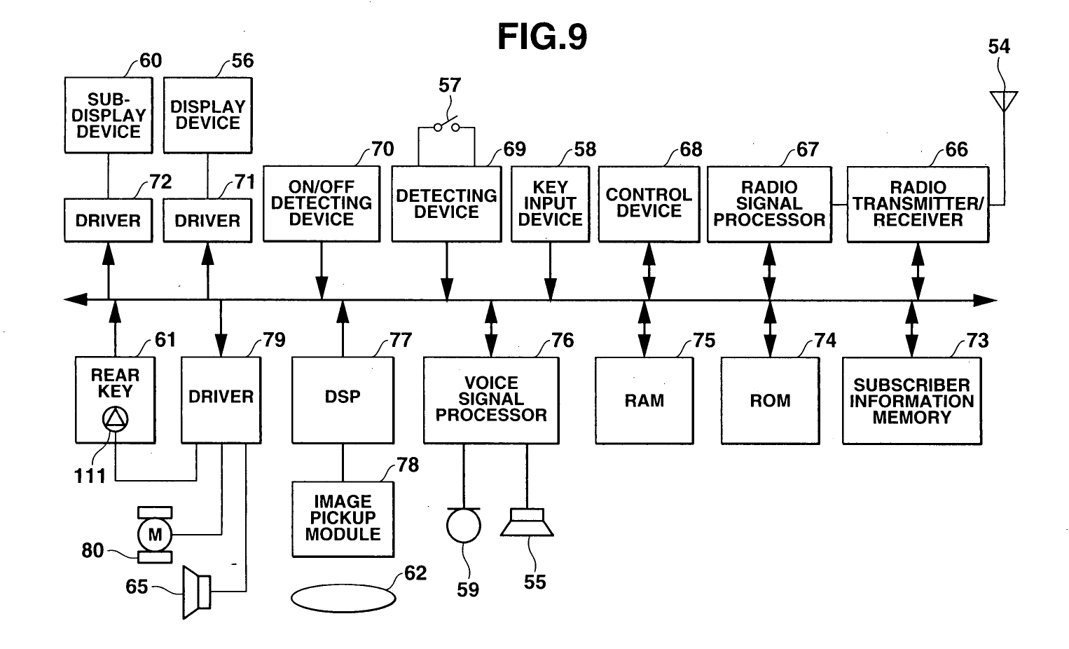

FIG. 9 is a block diagram showing a configuration of a portable telephone 51 according to this embodiment. A radio transmitter/receiver 66 wirelessly transmits/receives, through an antenna 54, and modulates/demodulates the data (including the electronic mail data) such as voice data, text data and image data. A radio signal processing unit 67 demodulates the data such as the voice data, the text data and the image data received through the radio transmitter/receiver 66, or modulates or otherwise processes the same data as required for radio communication. A control unit 68 controls both individual and overall operation of a cover unit 52 and a body unit 53 of the portable telephone 51 with camera described later.

A detecting unit 69 detects that a shutter key 57 is operated. An on/off detecting unit 70 comprises an optical sensor, a mechanical switch, etc. and detects whether the portable telephone 51 is in an open (the state in which the cover unit 52 and the body unit 53 are open) or a closed state (the state in which the cover unit 52 is covered on the body unit 53).

A driver 71 drives a display unit 56. A driver 72 drives a sub-display unit 60. A subscriber information storage unit 73 has stored therein the profile data such as the telephone numbers, the electronic mail addresses, the IDs of the operators (subscribers) for ringing up the portable telephone 51.

A ROM 74 has stored therein various programs for controlling the control unit 68. A RAM 75 is for storing various data required as a radio communication terminal, the data required for operation of the control unit 68, the image data picked up by an image pickup module 78 described later and the image data received by the radio transmitter/receiver 66. A voice signal processing unit 76 encodes the voice signal input from a microphone 59 and decodes the coded voice signal based on the signal output from the radio signal processing unit 67 and outputs it from a speaker 55.

A DSP (digital signal processor) 77 encodes the image data fetched into an image pickup module 78 through an image pickup lens 62. The image pickup module 78 comprises a CCD or a CMOS and fetches a color image. An announcing device 79 is a driver to drive an announcing speaker 65, a vibrator 80 and an LED 111.

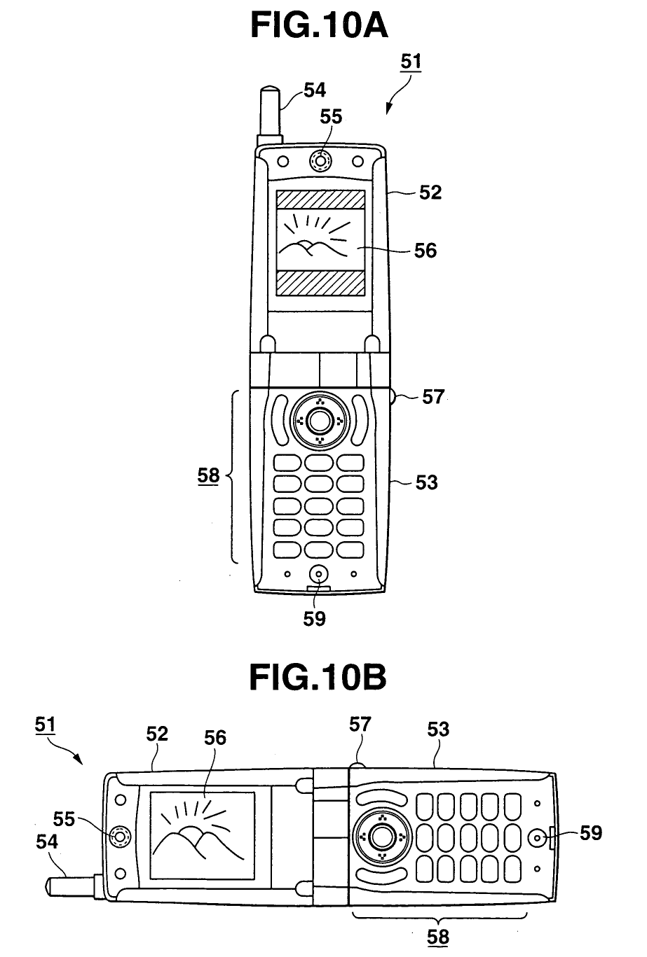

FIGS. 10A and 10B are a front view and a rear view, respectively, showing the external appearance of the portable telephone 51 (in open state) according to an embodiment of the invention. In FIGS. 10A and 10B, the portable telephone 51 is roughly configured of two units including the cover unit 52 and the body unit 53. The cover unit 52 is foldable toward the body unit 53. The antenna 54 is arranged on the back of the cover unit 52 and extendible.

The speaker 55 is arranged on the front side of the cover unit 52 and outputs a voice. A display unit (main display unit) 56 comprises a color liquid crystal, and upon detection of transfer to the camera mode with the cover unit 52 open, displays a through image. The shutter key 57 is arranged on the side surface of the body unit 53, and in the camera mode, is adapted to be depressed by the user to instruct the image pickup module 78 to pick up an image. A key input unit 58 is arranged on the front side of the body unit 53 and includes various function keys and ten-keys. The microphone 59 is arranged under the body unit 53 for inputting the voice.

A sub-display unit 60 (not shown) is arranged on the back of the cover unit 52. The display surface of the sub-display unit 60 is arranged substantially at right angles to the optical axis of the image pickup lens 62. The structure of the sub-display unit 60 will be described later. A back key 61 (not shown) comprises a transparent or translucent material and has built therein an LED emitting light upon receipt of a call. The image pickup lens 62 (not shown) is arranged on the back of the cover unit 52 under the sub-display unit 60. A battery pack 63 (not shown) is arranged removably on the reverse side of the body unit 53 and fixed by a lock unit 64 (not shown). The lock unit 64 is for fixing the battery pack 63 to the body unit 53. An announcing speaker 65 (not shown) for announcing the arrival of a call or mail is arranged on the reverse side of the body unit 53 so that the announcing sound is audible with the cover unit 52 closed on the body unit 53.

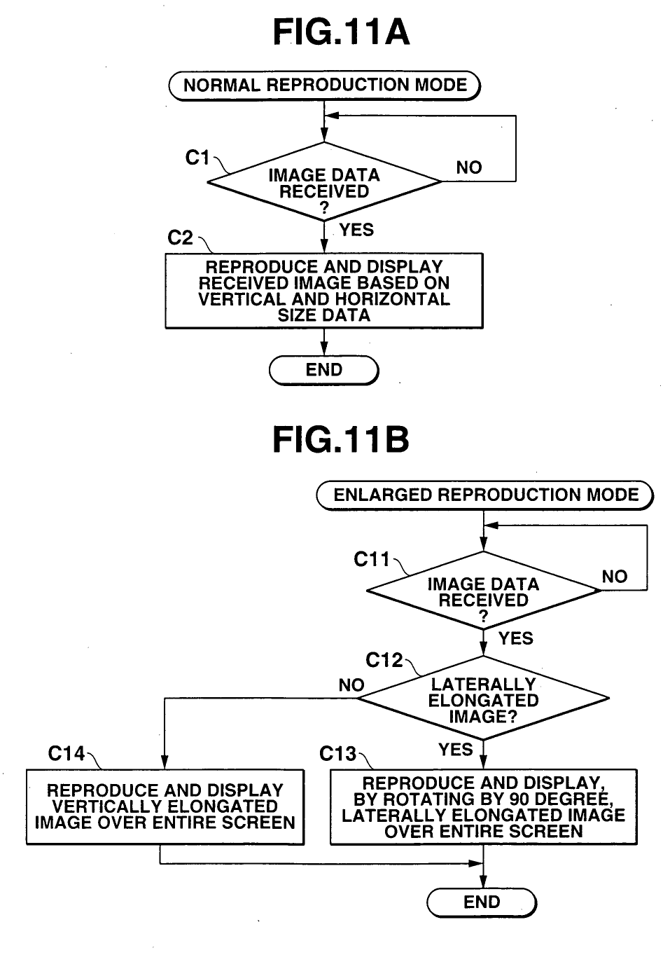

FIG. 11A shows the details of the process based on the operation program executed mainly by the control unit 68 while the normal reproduction mode is selected as a basic mode by the operation of the key input unit 58.

With the normal reproduction mode thus set, it is determined whether or not the radio transmitter/receiver 66 has received the image data (image file) (step C01). Upon detection of the receipt of the image data, the received image data is reproduced and displayed by the display unit 56 based on the data indicating the vertical and horizontal sizes (pixel size) added to the image data (contained in the image file) (step C02).

Specifically, assume that the data of the vertical and horizontal sizes added to the image data is “640 (horizontal) by 480 (vertical)” (horizontally long image) as shown in FIG. 8A. The image data is resized into a size accommodable in the display screen as shown in FIG. 10A, and the aspect ratio of the display image becomes different from that of the display unit 56, with the result that the image data is reproduced and displayed at the central portion of the display screen of the display unit 56.

If the vertical and horizontal size data added to the image data is “480 (horizontal) by 640 (vertical)” (vertically long image) as shown in FIG. 8B, on the other hand, the image data is resized into a size accommodable in the display screen. Since the aspect ratio of the display image becomes coincident with that of the display unit 56, the image data is reproduced and displayed over the entire area of the display screen of the display unit 56 as shown in FIG. 5B.

FIG. 11B shows the details of the process based on the operation program executed mainly by the control unit 68 while the enlarged reproduction mode is selected as a basic mode according to the invention by the operation of the key input unit 58.

With the enlarged reproduction mode set in this manner, it is determined whether or not the receipt of the image data (image file) by the radio transmitter/ receiver 66 is detected (step C11). When the receipt of the image data is detected, it is then determined whether the received image is vertically long or horizontally long, based on the data indicating the vertical and horizontal sizes (pixel size) added to the image data (contained in the image file) (step C12).

When it is determined that the received image is horizontally long, the image data is not reproduced and displayed as it is in accordance with the data indicating the vertical and horizontal sizes. Instead, as shown in FIG. 10B, the image data is rotated by 90 degrees while at the same time being resized into a size accommodable in the display screen, followed by the reproduction and display over the whole area of the display screen of the display unit 56 (step C13).

When it is determined in step C12 that the received image is vertically long, on the other hand, the image data is reproduced and displayed as it is in accordance with the data indicating the vertical and horizontal sizes. Thus, the image data is resized into a size accommodable in the display screen and then reproduced and displayed over the entire area of the display screen of the display unit 56 as shown in FIG. 5B (step C14). In short, a vertically long image is reproduced and displayed in the same manner as in the normal reproduction mode.

As described above, if the enlarged reproduction mode is selected, a vertically long image and a horizontally long image are both reproduced and displayed over the whole area of the display screen of the display unit 56, and therefore a larger image can be displayed.

If the user determines that the image reproduction in the enlarged reproduction mode shown in FIG. 11B is not required, the user selects the normal reproduction mode and thus can carry out the image reproduction in the normal reproduction mode shown in FIG. 11A, thereby reducing the burden on the control unit 68.

An explanation is made above about a case in which the received image is reproduced and displayed by the display unit 56 through the process in normal reproduction mode shown in FIG. 11A or in the enlarged reproduction mode shown in FIG. 11B. In spite of this, this invention is also applicable to a case in which the image data received by the radio transmitter/receiver 66 or the image data picked up by the image pickup module 78 and stored already in the RAM 75 is reproduced and displayed by the display unit 56. With regard to the image data picked up by the image pickup module 78, however, the vertical and horizontal positions of the portable telephone 51 at the time of the image pickup operation are detected by the vertical/horizontal position sensor 30 and the data indicating the vertical and horizontal sizes are automatically added to the image data as in the first embodiment. As an alternative, a shutter key used for the image pickup operation in the vertical position and a shutter key for the image pickup operation in the horizontal position are provided, and in accordance with which shutter key is operated, the data indicating the vertical and horizontal sizes are added. As another alternative, the images picked up in the vertical and horizontal positions are recorded indiscriminately at the time of the image pickup operation, after which the user inputs the vertical and horizontal sizes of the image by key input operation or the like and adds the vertical and horizontal sizes of the image to the image data recorded. As still another alternative, the image pickup operation in the vertical position or the image pickup operation in the horizontal position is selected by the user immediately before the image pickup operation, and according to which position is selected, the data indicating the vertical and horizontal sizes is added to the image data automatically at the time of image pickup operation. In this case, in place of the data indicating the vertical and horizontal sizes, the flag information indicating the image pickup position or the information indicating the bottom side (or the upper side) of the image may be added to the image data.

The aforementioned embodiments represent an application of the invention to a portable telephone with camera having a monitor display screen. The invention, however, is not limited to these embodiments, but can find application in all portable information terminals such as a portable telephone without camera, an electronic notebook or a PDA, and all portable equipment having a monitor display screen, such as a portable TV set. In short, the invention can be embodied as any device having a display unit for displaying an image having a different aspect ratio than that of the display unit.

Possible applications of the invention include not only a portable device having a monitor display screen as described above, but also a stationary image display apparatus such as an LCD monitor display of a desktop personal computer, in which a horizontally long screen can be rotated and used as a vertically long screen.

The embodiments described above represent a case in which a horizontally long image is displayed by a vertically long display unit in such a manner that the image data are rotated by 90 degrees and a horizontally long image is reproduced and displayed over the whole display screen of the display unit. As an alternative, a vertically long image is displayed by a horizontally long display unit in such a manner that the image data are rotated by 90 degrees and a vertically long image is reproduced and displayed over the whole area of the display screen of the display unit.

Also, the embodiments described above refer to a case in which the aspect ratio of an image and the aspect ratio of the display screen are coincident with each other. Even if the aspect ratio of the image fails to coincide with the aspect ratio of the display screen, however, the invention is still applicable as long as the image and the display screen have such an aspect ratio that the size of the image displayed in the enlarged reproduction mode can be rendered larger than the size of the image displayed in the normal reproduction mode.

The embodiments of the invention are described above with reference to a case in which a vertically long image and a horizontally long image are still images. Nevertheless, the image data handled are not limited to still images but may be dynamic images.

This invention is not confined to the embodiments described above, but variously modifiable without departing from the spirit and scope thereof.

What is claimed is:

1. An image display apparatus comprising:
an acquire unit which acquires an image;
a display unit which displays the image acquired by the acquire unit, the display unit having a display screen;
a detector which detects an orientation of the display screen of the display unit; and
a change unit which changes an orientation and a size of the image displayed by the display unit, based on a result of detection by the detector.

2. An image display apparatus according to claim 1, wherein the image has an aspect ratio other than one and the display screen has an aspect ratio other than one.

3. An image display apparatus according to claim 2, further comprising a determination unit which determines whether the image display apparatus is oriented vertically or horizontally,
wherein the detector detects the orientation of the display screen based on a result of determination by the determination unit.

4. An image display apparatus according to claim 2, further comprising a discrimination unit which discriminates the aspect ratio of the image acquired by the acquire unit,
wherein the change unit changes the orientation and the size of an image displayed by the display unit, based on a result of discrimination by the discrimination unit and the result of detection by the detector.

5. An image display apparatus according to claim 4, wherein the acquire unit acquires an image together with information indicating the aspect ratio of the image, and
the discrimination unit discriminates the aspect ratio of the image acquired by the acquire unit, based on the information indicating the aspect ratio..

6. An image display apparatus according to claim 4, wherein the acquire unit is able to acquire a vertically long image and a horizontally long image, and
the discrimination unit discriminates which of the vertically long image and the horizontally long image the acquire unit acquires.

7. An image display apparatus according to claim 6, wherein the vertically long image is a portrait image picked-up by a camera oriented vertically, and the horizontally long image is a landscape image picked-up by a camera oriented horizontally.

8. An image display apparatus according to claim 7, wherein the acquire unit includes an image pick-up device, and
the vertically long image is picked up by the image pick-up device with the image display apparatus being oriented vertically, and the horizontally long image is picked up by the image pick-up device with the image display apparatus being oriented horizontally.

9. An image display apparatus according to claim 8, further comprising a determination unit which determines whether the image display apparatus is oriented vertically or horizontally at a time of image pick-up by the image pick-up device,
wherein the discrimination unit discriminates which of the vertically long image and the horizontally long image is picked up by the image pick-up device, based on a result of determination by the determination unit.

10. An image display apparatus according to claim 9, further comprising a recording unit which records the image picked up by the image pick-up device and the result of determination by the determination unit with associating with each other,
wherein the acquire unit includes a unit which acquires the image and the result of determination by the determination unit which are recorded by the recording unit.

11. An image display apparatus according to claim 6, wherein, when the discrimination unit discriminates that a vertically long image is acquired by the acquire unit, the change unit changes the orientation and the size of the vertically long image displayed by the display unit, based on the result of detection by the detector.

12. An image display apparatus according to claim 11, wherein, when the detector detects that the display screen is oriented horizontally, the change unit causes a vertically long image displayed at a central portion other than left and right end portions of the display screen of the display unit, and when the detector detects that the display screen is oriented vertically, the change unit causes a vertically long image to be displayed over an entire area of the display screen.

13. An image display apparatus according to claim 6, wherein, when the discrimination unit discriminates that a horizontally long image is acquired, the change unit changes the orientation and the size of the horizontally long image displayed by the display unit, based on the result of detection by the detector.

14. An image display apparatus according to claim 13, wherein, when the detector detects that the display screen is oriented vertically, the change unit causes a horizontally long image to be displayed at a central portion other than upper and lower end portions of the display screen of the display unit, and when the detector detects that the display screen is oriented horizontally, the change unit causes a horizontally long image to be displayed over an entire area of the display screen.

15. An image display apparatus according to claim 2, further comprising a recording unit which records an image,
wherein the acquire unit acquires the image recorded by the recording unit.

16. An image display apparatus according to claim 15, wherein the recording unit records a plurality of images,
the apparatus further comprising a selector which selects at least one image from the plurality of images recorded by the recording unit, and
wherein the acquire unit acquires the image selected by the selector.

17. An image display apparatus according to claim 2, wherein the acquire unit an image pick-up device which acquires the image.

18. An image display apparatus according to claim 2, further comprising a setting unit which arbitrarily sets a first image reproduction mode,
wherein when the first image reproduction mode is set by the setting unit, the change unit changes the orientation and the size of an image displayed by the display unit, based on the result of detection by the detector.

19. An image display apparatus according to claim 18, further comprising a discrimination unit which discriminates the aspect ratio of the image acquired by the acquire unit,
wherein the setting unit further arbitrarily sets a second image reproduction mode different from the first image reproduction mode, and
when the second image reproduction mode is set by the setting unit, the change unit changes the orientation and the size of an image to be displayed by the display unit, based on the result of discrimination by the discrimination unit.

20. An image display apparatus comprising:
an image acquire unit which acquires an image;
a display unit which displays the image acquired by the image acquire unit, the display unit having a display screen;
an information acquire unit which acquires information indicating an aspect ratio of the image acquired by the image acquire unit; and
a determining unit which determines an orientation and a size of an image to be displayed by the display unit, based on the information indicating the aspect ratio acquired by the information acquire unit.

21. An image display apparatus according to claim 20, wherein the image has an aspect ratio other than one and the display screen has an aspect ratio other than one.

22. An image display apparatus according to claim 21, wherein the image acquire unit is able to acquire a vertically long image and a horizontally long image,
the apparatus further comprising a discrimination unit which discriminates which of the vertically long image and the horizontally long image is acquired by the image acquire unit, based on the information indicating the aspect ratio acquired by the information acquire unit, and
wherein the determination unit determines the orientation and the size of an image to be displayed by the display unit, based on a result of discrimination by the discrimination unit.

23. An image display apparatus according to claim 20, wherein the acquire unit receives an image.

24. An image display apparatus according to claim 21, further comprising a setting unit which arbitrarily sets a first image reproduction mode,
wherein, when the first image reproduction mode is set by the setting unit, the determination unit determines the orientation and the size of an image to be displayed by the display unit, based on the information indicating the aspect ratio acquired by the information acquire unit.

25. An image display apparatus comprising:
an image acquisition unit which acquires an image;
an image display unit which displays the image acquired by the image acquisition unit, the image display unit having a display screen;
a detector which detects an orientation of the display screen of the image display unit; and
a display control processor which changes an orientation and a size of an image displayed by the image display unit, based on a result of detection by the detector.

26. An image display apparatus comprising:
an image acquisition unit which acquires an image;
an image display unit which displays the image acquired by the image acquisition unit, the image display unit having a display screen;
an aspect ratio acquisition unit which acquires information indicating an aspect ratio of the image acquired by the image acquisition unit; and
a display control processor which determines an orientation and a size of an image to be displayed by the image display unit, based on the information indicating the aspect ratio acquired by the aspect ratio acquisition unit.

27. An image display method comprising:
acquiring an image;
detecting an orientation of an image display unit which displays the acquired image; and
changing an orientation and a size of an image displayed by an image display unit, based on a result of detection.

28. An image display method comprising:
acquiring an image;
acquiring information indicating an aspect ratio of the acquired image; and
determining an orientation and a size of an image to be displayed by an image display unit, based on the acquired information indicating the aspect ratio.

29. An article of manufacture comprising a computer usable medium having computer readable program code means embodied therein, the computer readable program code means comprising:
computer readable program code means for causing a computer to acquire an image;
computer readable program code means for causing a computer to detect an orientation of an image display unit which displays the acquired image; and
computer readable program code means for causing a computer to change an orientation and a size of an image displayed by the image display unit, based on the detected orientation.

30. An article of manufacture comprising a computer usable medium having computer readable program code means embodied therein, the computer readable program code means comprising:
computer readable program code means for causing a computer to acquire an image;
computer readable program code means for causing a computer to acquire information indicating an aspect ratio of the acquired image; and
computer readable program code means for causing a computer to determine an orientation and a size of an image displayed by an image display unit, based on the information indicating the aspect ratio of the acquired image acquired by code means.
